(19) United States
(12) Patent Application Publication
(10) Pub. No.: US 2007/0064421 A1
(43) Pub. Date: Mar. 22, 2007

(54) LIGHT SOURCE UNIT FOR USE IN A LIGHTING APPARATUS

(76) Inventor: Masatake Baba, Nakahara-ku (JP)

Correspondence Address: Norman P. Soloway;HAYES SOLOWAY P.C., Suite 140, 3450 E. Sunrise Drive, Tucson, AZ, 85718, US

(21) Appl. No.: 11/532,296

(22) Filed: Sep. 15, 2006

(30) Foreign Application Priority Data
Sep. 21, 2005 (JP) 2005-273994

(51) Int. Cl. F21V 9/00

(52) U.S. Cl. 362/231

(57) ABSTRACT

A backlight source of a LCD device includes constant-power red, green and blue LEDs emitting light having a constant output power, and a tone-correction red LED emitting light having a controlled output power controlled based on the temperature of the backlight source. The tone-correction red LED has a larger output power upon a temperature rise to supplement the reduced output power of the constant-power red LED.

### BACKGROUND OF THE INVENTION

(a) Field of the Invention

The present invention relates to a light source unit for use in a lighting apparatus and, more particularly, to a light source unit including light emitting diodes (LED).

(b) Description of the Related Art

In general, a LED or cold-cathode tube is used as a light source in a lighting apparatus such as a backlight unit in a liquid crystal display (LCD) device. The cold-cathode tube, which generally includes a dedicated ignition circuit and thus necessitates use of a higher voltage, has been used mainly in a large-dimension LCD device such as in a television or monitor set. On the other hand, the LED, which has a relatively lower brightness and a smaller occupied area, has been used mainly in a small-dimension LCD device such as in a cellular phone or personal data assistant (PDA). However, development of LEDs to have a larger output power and a higher luminance efficiency has allowed the LEDs to be used as backlight units in large-dimension LCD devices.

It is noted that the LED continuously emitting light in a long time interval is subjected to a higher device temperature to thereby lower the output power thereof. The degree of reduction in the output power associated with the higher device temperature generally depends on the materials used in the p-n junction of the LED, and is thus different between red, green and blue LEDs in the backlight unit. This may cause a chromaticity shift in a color LCD device using the LEDs in a backlight unit

In a literature entitled “RGB-LED Backlighting Monitor/TV for Reproduction of Images in Standard and Extended Color Spaces”, IDW '04 p. 683-686, the lighting apparatus described therein enables correction of chromaticity and brightness. FIG. 5 shows the configuration of the lighting apparatus described in the literature. The lighting apparatus 40 includes an optical guide plate 41, and a light source unit 42 disposed along a longer edge surface of the optical guide plate 41.

The light source unit 42 includes a substrate 45 having a main surface opposing the longer edge surface 41a of the optical guide plate 41, and LEDs 46 formed on the main surface of the substrate 45 and each emitting a red, green or blue light therefrom. The light emitted by the LEDs 46 is introduced through the longer edge surface 41a into the internal of the optical guide plate 41, and scattered uniformly within the optical guide plate 41, to be emitted through the front surface of the optical guide plate 41 in the direction normal to the sheet of the drawing.

The lighting apparatus 40 further includes an optical sensor unit 43 disposed on the other longer edge surface of the optical guide plate 41 opposing the lighting apparatus 40, an LED driver 44 for driving the light source unit 42, and a temperature sensor unit 47 disposed on the substrate 45 for detecting the substrate temperature. The optical sensor unit 43 has a function of detecting the intensity of the red, green and blue lights separately.

The LED driver 44 monitors the intensity of each of red, green and blue lights detected by the optical sensor unit 43, and controls the output power of the LEDs 46 so that the lighting apparatus 40 outputs specified chromaticity and brightness. The LED driver 44 also monitors the substrate temperature of the lighting apparatus 40 measured by the temperature sensor 47, to correct the change of output power of the LEDs 46 caused by the temperature change of the substrate 45.

The lighting apparatus 40 described in the literature uses calculation of the output power of the LEDs 46 based on the signals supplied from the optical sensor 43 and the temperature sensor 47. Calculation for the correction complicates the control of the power to be supplied from the power source to the LEDs 46 and thus necessitates use of a dedicated IC chip for the LED driver 44. In addition, the cost of the optical sensor unit 43 raises the cost of the lighting apparatus 40. The optical sensor unit 43 also has a large occupied area to increase the dimensions of the lighting apparatus 40. Thus, it is desired to simplify the lighting apparatus which emits light having desired chromaticity and brightness.

### SUMMARY OF THE INVENTION

In view of the above, it is an object of the present invention to provide a lighting apparatus suited to backlight source unit capable of having a simplified structure and emitting light having desired color and brightness.

It is another object of the present invention to provide a light source unit for use in the lighting apparatus, and a LCD device including the lighting apparatus.

The present invention provides a light source unit including: a plurality of light-emitting-diodes (LEDs), the LEDs including at least one constant-power LED and at least one tone-correction LED; and a power control unit for controlling an output power of the tone-correction LED based on a temperature of the lighting apparatus, and maintaining the output power of the constant-power LED with respect to the temperature of the lighting apparatus.

The present invention also provides a lighting apparatus including a light source unit and an optical guide plate for receiving light emitted by the light source unit and emitting the received light, the light source unit including: a plurality of light-emitting-diodes (LEDs), the LEDs including at least one constant-power LED and at least one tone-correction LED; and a power control unit for controlling an output power of the tone-correction LED based on a temperature of the light source unit, allowing the output power of the constant-power LED to be fixed with respect to the temperature of the light source unit.

The present invention also provides a liquid crystal display device including a lighting apparatus for emitting light: and a liquid crystal display panel for receiving light emitted by the lighting apparatus as backlight, the lighting apparatus comprising: a light source unit and an optical guide plate for receiving light emitted by the light source unit and emitting the received light, the light source unit including: a plurality of light-emitting-diodes (LEDs), the LEDs including at least one constant-power LED and at least one tone-correction LED; and a power control unit for controlling an output power of the tone-correction LED based on a temperature of the lighting apparatus, and maintaining the output power of the constant-power LED with respect to the temperature of the lighting apparatus.

In accordance with the light source unit of the present invention, and the light source unit used in the lighting apparatus and LCD device of the present invention, the chromaticity shift and/or brightness change of the constant-power LED caused by a temperature change of the light source unit can be cancelled by the control of the output power of the tone-correction LED based on the temperature. This is achieved without using an optical sensor in the lighting apparatus, to thereby reduce the dimensions of the lighting apparatus.

The above and other objects, features and advantages of the present invention will be more apparent from the following description, referring to the accompanying drawings.

### BRIEF DESCRIPTION OF THE DRAWINGS

FIG. 1 is a schematic front view of a lighting apparatus according to a first embodiment of the present invention.

FIG. 2 is a block diagram of the light source unit shown in FIG. 1.

FIG. 3 is a graph showing the relationship between the temperature of the p-n junction and the normalized output power of the LEDs.

FIG. 4 is a block diagram of another light source unit.

FIG. 5 is a block diagram of a conventional lighting apparatus.

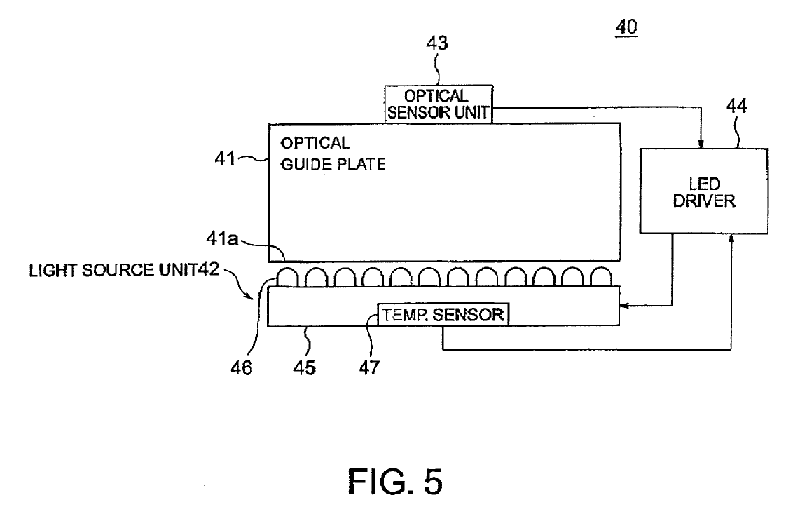

### PREFERRED EMBODIMENT OF THE INVENTION

Now, the present invention is more specifically described with reference to accompanying drawings, wherein similar constituent elements are designated by similar reference numerals.

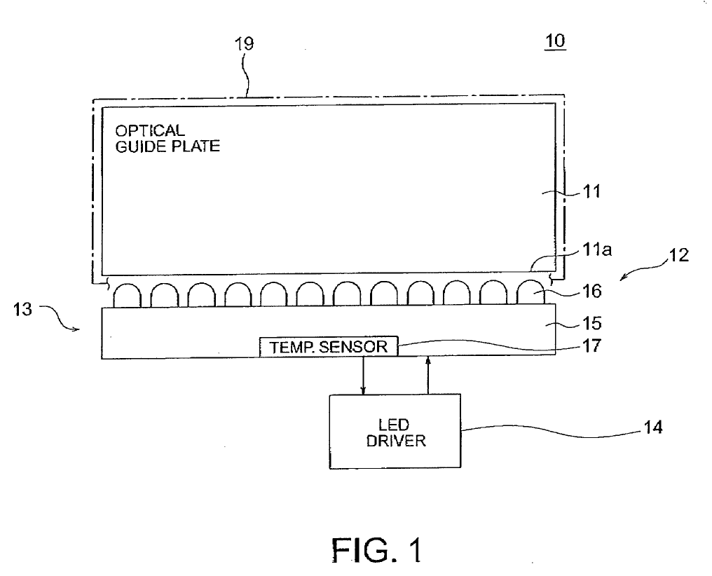

Referring to FIG. 1, a lighting apparatus, generally designated by numeral 10, includes an optical guide plate 11, and a light source unit 12 disposed along a longer edge surface 11a of the optical guide plate 11. The light source unit 12 is configured as a backlight unit for use in a LCD device. In FIG. 1, a LCD panel 19 in the LCD device is shown by a dotted line. The LCD panel 19 is disposed in front of the lighting apparatus 10 to receive the light emitted by the lighting apparatus 10.

The light source unit 12 includes a LED array 13, and a LED driver 14 connected to the LED array 13. The LED array 13 includes a substrate 15, a plurality of LEDs 16 arranged in a row on the surface of the substrate 15 opposing the longer edge surface 11a of the optical guide plate 11, and a temperature sensor 17 disposed on the substrate 15 for detecting the substrate temperature of the light source unit 12. The LED driver 14 is connected to the LEDs 16 and temperature sensor 17.

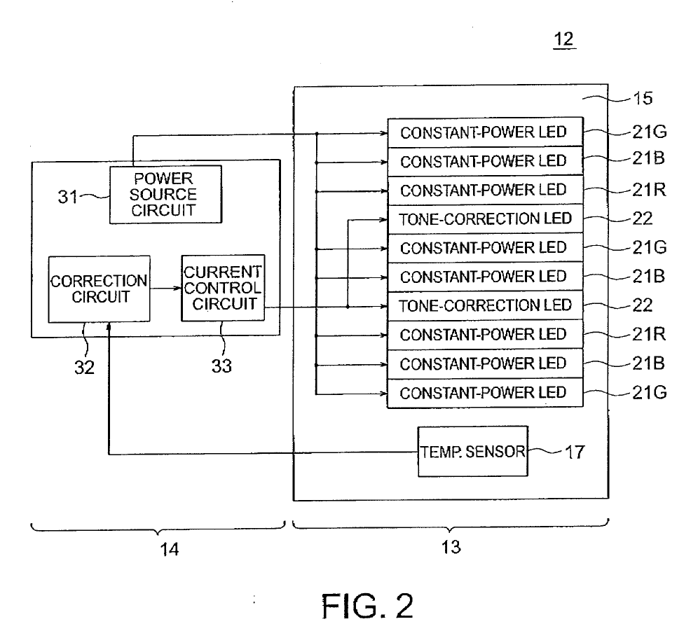

FIG. 2 is a block diagram of the light source unit 12 shown in FIG. 1. The LEDs 16 shown in FIG. 1 include a plurality of constant-power LEDs 21 which are driven at a constant power, and a plurality of tone-correction LEDs 22 which are driven at a controlled power controlled based on the temperature of the substrate 15. The constant-power LEDs 21 includes red LEDs 21R, green LEDs 21G and blue LEDs 21B, all of which emit respective colored lights. The tone-correction LEDs 22 include red LEDs which emit a red light. These LEDs 21, 22 are arranged at a constant pitch on the substrate 15, and the tone-correction LEDs 22 are disposed adjacent to the constant-power red LEDs 21R. It is to be noted that the tone-correction LEDs 22 may be disposed on another substrate.

In the present embodiment, the temperature sensor 17 is configured by a thermistor, which assumes a resistance depending on the temperature of the substrate 15. Use of the thermistor is especially preferable because of the small dimensions and easy arrangement thereof, thereby scarcely affecting the dimensions and shape of the light source unit 12.

The LED driver 14 includes a power source circuit 31, a correction circuit 32, and a current control circuit 33. The power source circuit 31 connects to the constant-power LEDs 21R, 21G, 21B and supply a constant power to each of the constant-power LEDs 21R, 21G, 21B.

The correction circuit 32 connects to the temperature sensor 17 and current control circuit 33, and includes therein a look-up table which shows the relationship between the resistance of the temperature sensor 17 and the amount of control to be supplied to the current control circuit 33. The resistance of the temperature sensor 17 in the look-up table may be replaced by a terminal voltage of the temperature sensor 17 converted from the resistance. The correction circuit 32 generates a control signal based on the resistance that the temperature sensor 17 delivers as temperature information of the lighting apparatus, by referring to the look-up table.

The current control circuit 33 connects to the correction circuit 32 and tone-correction LEDs 22. The current control circuit 33 receives the control signal from the correction circuit 32, controlling the power to be supplied to the tone-correction LEDs 22 based on the received control signal. The control of the power supplied to the tone-correction LEDs 22 may use a constant-current control technique, a duty ratio control technique based on a pulse width modulation (PWM) signal, and so on.

Back to FIG. 1, the optical guide plate 11 receives through the longer edge surface 11a the light emitted by the light source unit 12, scatters the received light within the optical guide plate 11, and emits the scattered light through the front surface thereof toward the LCD panel 19 in the direction normal to the sheet of the drawing.

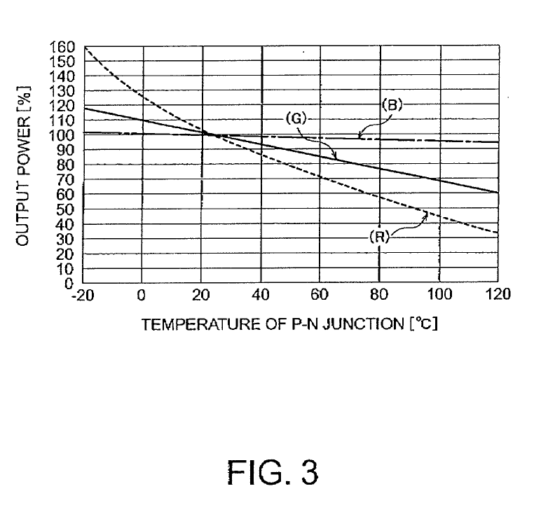

FIG. 3 shows an example of the general relationship between the output power of color LEDs and the temperature of the p-n junction of the color LEDs. The output power plotted on ordinate is normalized by the output power at a specific temperature (around 25 degrees), and shown in terms of percents. As understood from FIG. 3, the degree of reduction in the output power is larger in red LEDs, medium in green LEDs and smaller in blue LEDs. The look-up table stored in the correction circuit 32 is created based on the relationship such as shown in FIG. 3, and is designed to redeem or supplement the reduction in the output power of the constant-power red LEDs 21R upon a temperature rise.

In FIG. 3, the green LED and blue LED experience a less degree of reduction in the output power upon a temperature rise compared to the red LED. Thus, in the present embodiment, the tone-correction red LEDs 22 increase the output power thereof along with the temperature rise, thereby correcting the tone or chromaticity shift as well as the brightness reduction of the light caused by the temperature rise. This provides stable chromaticity and brightness for the light emitted by the lighting apparatus 10.

As described above, the output power of the tone-correction red LEDs 22 is controlled based on the temperature of the substrate 15 to correct the tone and brightness shift of the light emitted by the constant-power LEDs 21R, 21G, 21B. The lighting apparatus 10 of the present embodiment obviates provision of an optical sensor and a dedicated IC chip for correcting the chromaticity shift of the emitted light caused by the temperature change. Thus, the tone and brightness correction is achieved by a simple structure at a lower cost.

It is to be noted that the tone-correction LEDs 22 may further include one or more green LEDs and one or more blue LEDs, for achieving the tone and brightness correction with a higher accuracy and within a broader temperature range. In such a case, the lighting apparatus 10 may include another correction circuit and another current control circuit for the green LEDs and blue LEDs.

If the tone-correction LEDs include red, green and blue LEDs, the red LEDs may be operated in a higher temperature range whereas the green and/or blue LEDs may be operated in a lower temperature range. The tone-correction LEDs may include only blue LEDs, which are controlled to reduce the output power thereof upon a temperature rise, or in a higher temperature range.

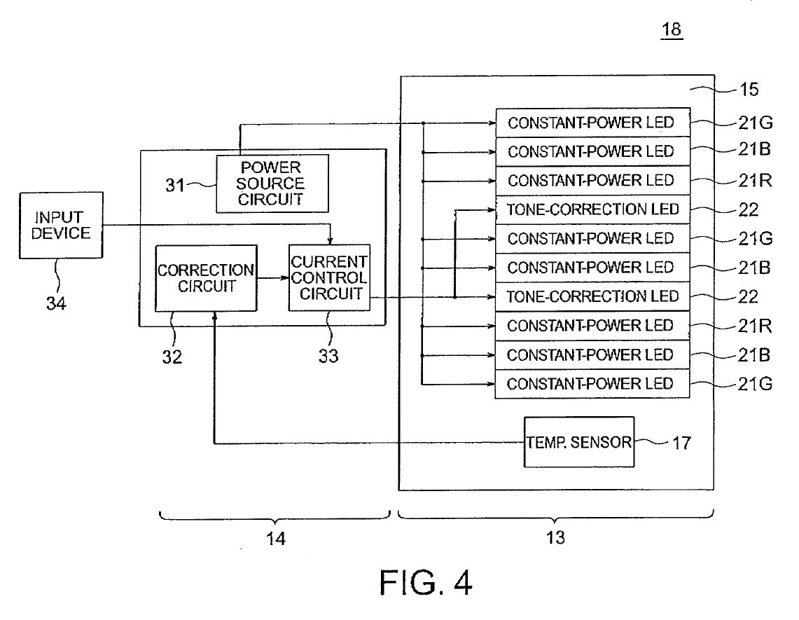

FIG. 4 shows a block diagram of another light source unit 18 used in a lighting apparatus according to a second embodiment of the present invention. The light source unit 18 is similar to the light source unit 17 of FIG. 2 except that the light source unit 18 includes an input device 34. The input device 34 receives an input signal from a user to deliver the same to the current control circuit 33.

The current control circuit 33 is controlled by the input signal to control the output power of the tone-correction LEDs 22 in addition to the control by the temperature signal supplied from the temperature sensor 17 shown in FIG. 1. The other configuration of the lighting apparatus of the present embodiment is similar to that of the lighting apparatus 10 of the first embodiment.

The user of the lighting apparatus enters the input signal through the input device 34 to control the current control circuit 33 for emitting a light having desired tone and brightness. The input device 34 may deliver the input signal to the power source circuit 31, to control the power source circuit such as 31 in FIG. 2 for controlling the output power of the constant-power LEDs 21R, 21G, 21B. The term “constant-power” as used herein means the power which is constant with respect to the temperature change of the lighting apparatus.

Since the above embodiments are described only for examples, the present invention is not limited to the above embodiments and various modifications or alterations can be easily made therefrom by those skilled in the art without departing from the scope of the present invention.

What is claimed is:

1. A light source unit comprising:
a plurality of light-emitting-diodes (LEDs), said LEDs including at least one constant-power LED and at least one tone-correction LED; and
a power control unit for controlling an output power of said tone-correction LED based on a temperature of said lighting apparatus, and maintaining the output power of said constant-power LED with respect to the temperature of said lighting apparatus.

2. The light source unit according to claim 1, wherein said at least one constant-power LED include red, green and blue LEDs.

3. The light source unit according to claim 2, wherein said at least one tone-correction LED includes a tone-correction red LED, and said power control unit increases the output power of said tone-correction red LED upon a temperature rise.

4. The light source unit according to claim 2, wherein said at least one tone-correction LED include tone-correction red and green LEDs, and said power control unit increases the output power of said tone-correction red and green LEDs upon a temperature rise.

5. The light source unit according to claim 2, wherein said at least one tone-correction LED includes a tone-correction blue LED, and said power control unit reduces the output power of said tone-correction blue LED upon a temperature rise.

6. The light source unit according to claim 1, further comprising an input device for receiving a control signal controlling the output power of said constant-power LED and/or tone-correction LED.

7. A lighting apparatus comprising a light source unit and an optical guide plate for receiving light emitted by said light source unit and emitting said received light, said light source unit including:
a plurality of light-emitting-diodes (LEDs), said LEDs including at least one constant-power LED and at least one tone-correction LED; and
a power control unit for controlling an output power of said tone-correction LED based on a temperature of said light source unit, allowing the output power of said constant-power LED to be fixed with respect to the temperature of said light source unit.

8. A liquid crystal display device comprising: a lighting apparatus for emitting light; and a liquid crystal display panel for receiving light emitted by said lighting apparatus as backlight, said lighting apparatus comprising a light source unit and an optical guide plate for receiving light emitted by said light source unit and emitting said received light, said light source unit including:
a plurality of light-emitting-diodes (LEDs), said LEDs including at least one constant-power LED and at least one tone-correction LED; and
a power control unit for controlling an output power of said tone-correction LED based on a temperature of said lighting apparatus, and maintaining the output power of said constant-power LED with respect to the temperature of said lighting apparatus.
